(19) United States
(12) Patent Application Publication
(10) Pub. No.: US 2019/0087676 A1
(43) Pub. Date: Mar. 21, 2019

(54) Information Retrieval System

(71) Applicant: Kevin Webb, Augusta, ME (US)

(72) Inventor: Kevin Webb, Augusta, ME (US)

(21) Appl. No.: 15/706,686

(22) Filed: Sep. 16, 2017

(51) Int. Cl. G06K 9/20; G06K 9/18; G06F 17/30; G06K 9/22

(52) U.S. Cl. CPC G06K 9/2054; G06K 9/18; G06K 2209/01; G06K 9/228; G06F 17/30876

(57) ABSTRACT

A computer-implemented system and method for recognizing specific text patterns using a camera and redirecting users to content associated with the text. In an example, part of the system (e.g., a mobile phone) receives a camera input and recognizes text surrounded by a predetermined pattern of special characters (e.g., #CMoreApple##). The system then directs a browser to content associated with the text (e.g., an Apple web site) for viewing by a user.

### BACKGROUND

Print advertisements are used to attract customers. However, in general these ads fail to provide a way to obtain information of the products or services being advertised beyond the advertisement itself. For example, if a prospective customer reads a traditional print advertisement in magazine or newspaper ad and is interested in obtaining more information, they have to obtain it independently of the ad. This may involve online activities such as performing online searches, seeking out online reviews and the like, typically involving the use of a search engine. These searches are necessarily unique to the prospective customer and may lead to undesirable results because there is no way to control the search engines selected, or the search queries submitted, of the results of the queries, or to control reviews and criticisms, etc. Some ads may provide a web address, but it is typically just the web address of the company making the offer, and not to a site giving more information of the offering. In general, such web sites don't provide information that is easy to find and relevant to the specific advertised offering.

It is with respect to these and other general considerations that solutions will be described involving new and useful methods, apparatus, and systems of retrieving information pertaining to printed subject matter. Although relatively specific scenarios and challenges are discussed, in particular with reference to print advertising, it should be understood that the described aspects and embodiments are illustrative and not limiting. The described aspects and embodiments should not be construed to apply only to solving the specific problems identified and the specific solutions described herein.

### SUMMARY

A computer-implemented system and method for retrieving information by recognizing specific text patterns and redirecting users to content associated with the recognized patterns. In an exemplary embodiment, the system may comprise a smartphone with a camera. An app running on the phone receives camera input and recognizes text surrounded by a predetermined pattern of special characters (e.g., #CMoreApple123##). The system then redirects a user to content associated with the text (e.g., apple.com/123content).

In particular embodiments, an application on a smartphone periodically captures images and performs image pattern analysis on each image, which may include Optical Character Recognition (OCR). The application then compares the recognized ordered characters to known patterns of special characters to determine if sets of the recognized characters match any of the known patterns. If there is a match, the application may initiate an action, such as directing an app such as a web browser of the phone to content associated with the matched pattern of characters. In an exemplary embodiment, the application may communicate with a remote server and transmit the matched character pattern to the server. The server may then compare the recognized character pattern with a list of redirection identifiers, and if a match is found, the server may send a corresponding redirection link to the app running on the smart phone, and the phone follows the link.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is defined by the claims.

In the drawings:

FIG. 1 is a block diagram illustrating physical components of an exemplary computing device with which aspects of the disclosure may be practiced.

FIGS. 2A and 2B are simplified diagrams of a mobile computing device with which aspects of the present disclosure may be practiced.

FIG. 3 is a simplified block diagram of a distributed computing system in which aspects of the present disclosure may be practiced.

FIG. 4 illustrates a printed page of classified advertisements including exemplary ads in accordance with aspects of the present disclosure.

FIG. 5 illustrates an exemplary table containing information in accordance with aspects of the present disclosure.

FIG. 6 illustrates an exemplary client application in accordance with aspects of the present disclosure.

FIG. 7 illustrates an exemplary web page in accordance with aspects of the present disclosure.

FIG. 8 is a flow chart of an exemplary method carried out by a server in accordance with aspects of the present disclosure.

FIG. 9 is a flow chart of an exemplary method carried out by a mobile communication device in accordance with aspects of the present disclosure.

### DETAILED DESCRIPTION

It is to be understood that the figures and descriptions provided herein may have been simplified to illustrate aspects that are relevant for a clear understanding of the herein described processes, machines, manufactures, and/or compositions of matter, while eliminating, for the purpose of clarity, other aspects that may be found in the prior art. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure should be understood to inherently include all such elements, variations, and modifications to the described aspects that would be known to those of ordinary skill in the pertinent art.

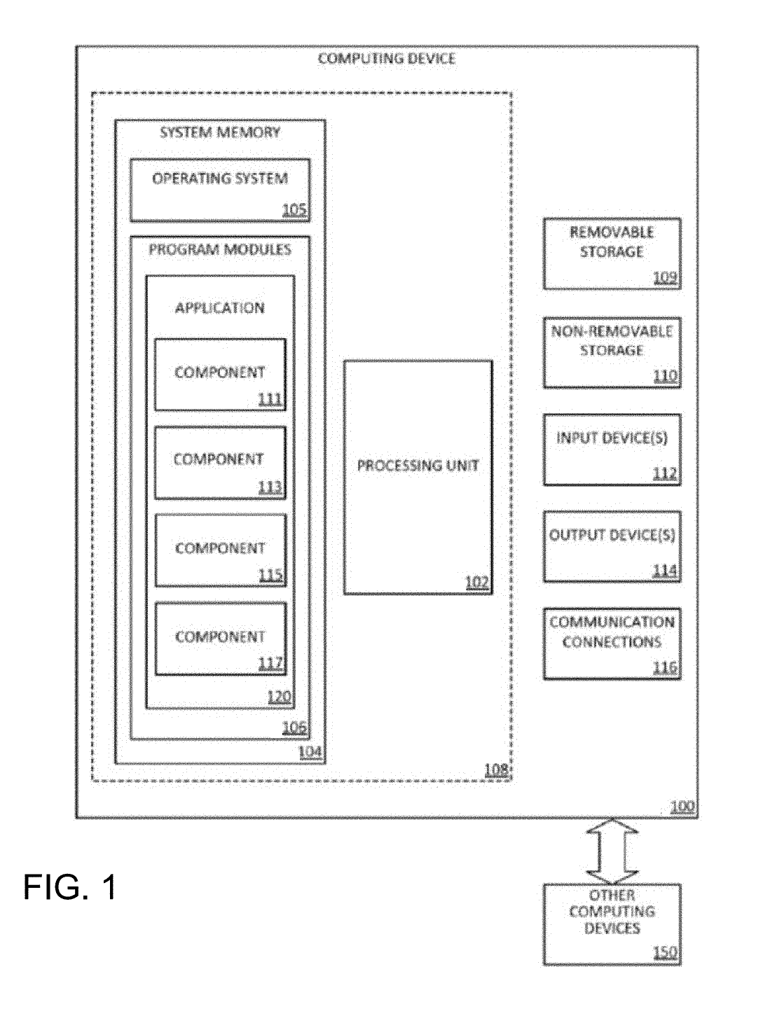

As an initial matter, FIGS. 1-3 illustrate exemplary operating environments in which aspects of the disclosed embodiments may be practiced. The devices and systems illustrated and described with respect to FIGS. 1-3 are presented for purposes of example and illustration, and are not limiting of other computing devices and configurations that may be utilized for practicing aspects of the described embodiments.

FIG. 1 is a block diagram illustrating physical components of a computing device 100 with which aspects of the disclosure may be practiced. The computing device 100 may have computer executable instructions for implementing aspects of an information retrieval and delivery system. In embodiments, computing device 100 can be illustrative of a mobile user device, or a server computing device, or both. In a basic configuration the computing device 100 may include at least one processing unit 102 and a system memory 104. Depending on the configuration and type of computing device, the system memory 104 may comprise, but is not limited to, volatile storage (e.g., random access memory), non-volatile storage (e.g., read-only memory), flash memory, or any combination of such memories. The system memory 104 may store an operating system 105 and one or more program modules 106 suitable for running application 120. The operating system 104, programs modules 106, and application 120 with one or more components shown as 111, 113, 115, and 117, all comprise computer executable instructions that can be executed to realize the methods disclosed herein.

It is contemplated that the operating system 105 running on a mobile user device may be a smart phone running either the iOS by Apple Computer, or the Android operation system by Google, although other mobile devices and mobile device operating systems may be used. Moreover, it is contemplated the server may be a rack-mounted server running a version of Windows by Microsoft, or any of a variety of Unix-based operating systems, although other server configurations and server operating systems may be used. However, disclosed embodiments may be practiced in connection with hardware configurations, operating systems, program modules, applications, and/or application components other than those illustrated and described, and are not limited to any particular application or system.

In general, the operating system 105 controls aspects of the operation of the computing device elements illustrated in FIG. 1 within dashed line 108. The computing device 100 may have additional features or functionality. For example, it may also include additional data storage devices (removable and/or non-removable) such as, for example, magnetic disks, optical disks, or magnetic tape. Such additional storage is illustrated in FIG. 1 by removable storage device 109 and non-removable storage device 110.

A plurality of program modules and data files may be stored in memory 104. While executing on the processing unit 102, program modules 106 may perform processes including, but not limited to, herein described aspects and embodiments. In the case computing device 100 is a mobile user device, user (i.e., client) application 120 may include image capture component 111, OCR component 113, character pattern analysis component 115, and information retrieval component 117. In the case computing device 100 is a server computing device, server application 120 may include process component 111, retrieve component 113, HTML creation component 115, and delivery component 117.

It is understood that described embodiments may be practiced using electrical circuits comprising discrete electronic elements, packaged or integrated electronic chips containing logic gates, a circuit utilizing a microprocessor, or on a single chip containing electronic elements or microprocessors. For example, embodiments may be practiced using an application specific integrated circuit (ASIC), or a system-on-a-chip (SOC), where each or many of the components illustrated in FIG. 1 may be integrated onto a single integrated circuit. Such an ASIC or SOC device may include one or more processing units, graphics units, communications units, system virtualization units and various application functionality, all of which may be integrated onto a substrate as a single integrated circuit. When operating via an ASIC or SOC, the functionality described herein may be operated via application-specific logic integrated with other components of the computing device 100, which may be included on the integrated circuit. Embodiments may also be practiced using other technologies capable of performing logical operations such as, for example, AND, OR, and NOR, including but not limited to mechanical, optical, and quantum technologies. Aspects of disclosed embodiments may also be practiced within a general purpose computer. In such case, the computer elements utilized together with the computer instructions running on them realize a special purpose computer specific to those described aspects and embodiments.

Computing device 100 may have one or more input device(s) 112 such as a keyboard, a mouse, a pen, a microphone, a touch screen, etc. One or more output device(s) 114 may also be included, such as a display, a speaker, a printer, etc. Computing device 100 also includes one or more communication connections 116 allowing communication with other computing devices 150. Examples of suitable communication connections 116 include, but are not limited to, circuitry such as cellular and/or wifi radio frequency (RF) transmitter, receiver, and/or transceiver circuitry; busses such as universal serial bus (USB), parallel, and/or serial ports; and/or other network interface technologies known in the art.

The term computer readable media as used herein means a tangible computer readable digital data storage device. Computer storage media may include any or all of volatile and nonvolatile media, removable and non-removable media, implemented in any method or associated tangible technology for storage of information, such as computer readable instructions, data structures, and program modules. The system memory 104, the removable storage device 109, and the non-removable storage device 110 are all examples of computer storage media. Computer storage media may include RAM, ROM, electrically erasable programmable read-only memory (EEPROM), flash memory or other memory technology, CD-ROM, DVD or other optical storage, magnetic tape cassette storage, magnetic disk storage or other magnetic storage devices, solid state memory such as solid state drives (SSDs) or USB thumb drives, or any other article of manufacture which can be used to store information and which can be accessed by the computing device 100. Such computer storage media may be part of or operatively coupled to the computing device 100. As used herein, computer storage media does not include a carrier wave or other propagated or modulated data signal.

In embodiments, the mobile device and the server are operatively coupled via a network such as the Internet that includes communication media such as a wired network or direct-wired connection, and wireless media and interfaces such as radio frequency (RF), infrared, and/or other wireless media.

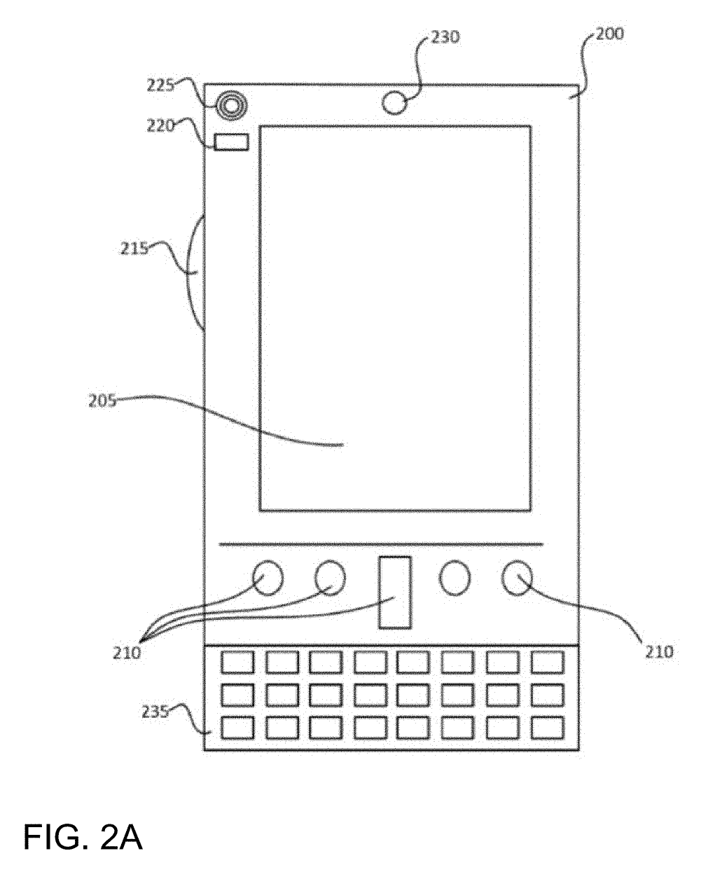

FIGS. 2A and 2B illustrate a mobile computing device 200, which may be referred to herein as a user device or a “mobile”. Mobile 200 may include some or all of the blocks shown in FIG. 1. In embodiments, mobile 200 may be a mobile telephone such as a smart phone as illustrated in FIGS. 2A and 2B, or a wearable computing device such as a smart watch, a tablet computer, a laptop computer, and the like, with which aspects of the disclosure may be practiced. In some aspects, such a mobile computing device may act as a client in a client-server arrangement. With reference to FIG. 2A in a basic configuration, the mobile computing device 200 is a smart phone or other handheld computer having both input elements and output elements. The mobile 200 may include one or more physical buttons 210 that act as user inputs to the mobile 200. Display 205 may also function as an input device (e.g., a touch screen display). A side input element 215 may also be included to allow further user input. For example, side input element 215 may be a rocker switch, a button, or any other type of physical input element. In various embodiments, mobile computing device 200 may incorporate more or fewer input elements. For example, a touchscreen embodiment may include a “soft” virtual keypad and/or other virtual inputs presented on the touchscreen. In other embodiments, the display 205 may not be a touch screen. Such embodiments may include a physical keypad 235. Output elements may include the display 205 showing a graphical user interface (GUI), a visual indicator 220 such as a light emitting diode (LED), and/or an audio transducer 225 such as a speaker. Mobile computing device 200 may also incorporate a vibration transducer for providing the user with tactile feedback. In yet another aspect, the mobile computing device 200 may include input and/or output ports, such as an audio input jack into which a microphone may be plugged, an audio output jack into which a headphone may be plugged, and a video output such as an HDMI port for sending or receiving video signals to or from an external video device.

FIG. 2B is a block diagram illustrating certain system aspects 202 within mobile computing device 200. One or more application programs 266 may be loaded into memory 262 and run under or in association with the operating system 264. Such application programs may include, for example, image capture and processing programs, word processors, spreadsheets, Internet browsers, messaging programs, and so forth. System aspects 202 also include a non-volatile storage area 268 within the memory 262. The non-volatile storage area 268 may be used to store persistent information that is not lost when user device 200 is powered down. The application programs 266 may use and store information in the nonvolatile storage area 268, such as information about personal contacts, text messages sent and received, and any information saved for later use by apps 266. For backup, a synchronization application may also reside within user device 200, programmed to interact with a host computer to store information at the host computer and to keep the stored information synchronized with the information stored in the non-volatile storage area 268. The host computer may be a server accessible via a network, or a directly connected personal computer (PC), for example.

The user device 200 includes a power supply 270, which may be implemented as an internal rechargeable battery. The power supply 270 may be coupled to an external power source such as an external battery, AC adapter, or powered docking cradle that supplements and/or recharges the internal battery.

User device 200 may also include a radio interface layer 272 that performs the function of transmitting and receiving radio frequency communications. The radio interface layer 272 facilitates wireless connectivity between user device 200 and a network operated by a communications carrier or service provider. Communications to and from the radio interface layer 272 are conducted under control of the operating system 264. As such, incoming communications received by the radio interface layer 272 may be directed by the operating system 264 to one or more application programs 266; and outgoing communications may be generated by application programs 266 and directed by the operating system 264 to the radio interface layer 272 and transmitted.

Visual indicator 220 may be used to provide visual notifications. Audio interface 274 may additionally or alternatively be used for producing audible notifications via the audio transducer 225. In the illustrated embodiment, the visual indicator 220 is a light emitting diode (LED) and the audio transducer 225 is a speaker. These devices may be directly coupled to the power supply 270 so that when activated, they remain on for a period of time controlled by the notification mechanism even though the processor 260 and other components might enter a low power state or shut down to conserve battery power. The LED may be programmed to remain on until the user takes an action related to the indicator. The audio interface 274 is used to provide audible signals to and receive audible signals from the user. For example, in addition to being coupled to the audio transducer 225, the audio interface 274 may also be coupled to a microphone to receive audible input, such as to facilitate a telephone conversation. In accordance with certain aspects and embodiments, the microphone may also serve as an audio sensor to facilitate control of notifications or to provide other user input. User device 200 may further include a video interface 276 that enables operation of an onboard camera 230 to record one or more still images, a video stream, and the like.

Mobile computing device 200 may have additional features or functionality. For example, the mobile 200 may also accommodate removable data storage devices such as a microSD card. Such additional storage is represented in FIG. 2B by the non-volatile storage area 268.

Information and data generated or captured by the mobile computing device 200 may be stored locally on the mobile 200, or may be stored on any number of external storage media. Such media may be accessed for example by the mobile 200 via the radio interface layer 272, or via a wired connection between the mobile 200 and a separate computing device associated with the mobile 200, such as an on-the-go (OTG) connected thumb drive for example. Alternatively or in addition, data may be sent to a server computer in a distributed computing network, such as the Internet, for storage. The data may thereafter be accessed by the mobile 200 via the radio interface layer 272 or other network interface to the server or other network storage location for retrieval. Similarly, such data/information may be readily transferred between computing devices and storage devices for use in accordance with the present disclosure.

Applications 266 may be stored in non-volatile storage 268, and loaded into memory 262 to run on processor 260 of mobile 200. A client app that operates in accordance with aspects of the present disclosure can be downloaded from an online program repository or “app store”. Other methods of a user device acquiring an app may alternatively be used. Such a program includes program instructions for implementing the user mobile device (or client) portion of an information retrieval system as disclosed herein. In particular, as described in connection with FIG. 1, such an app may include an image capture component 111, OCR component 113, character pattern analysis component 115, and information retrieval component 117.

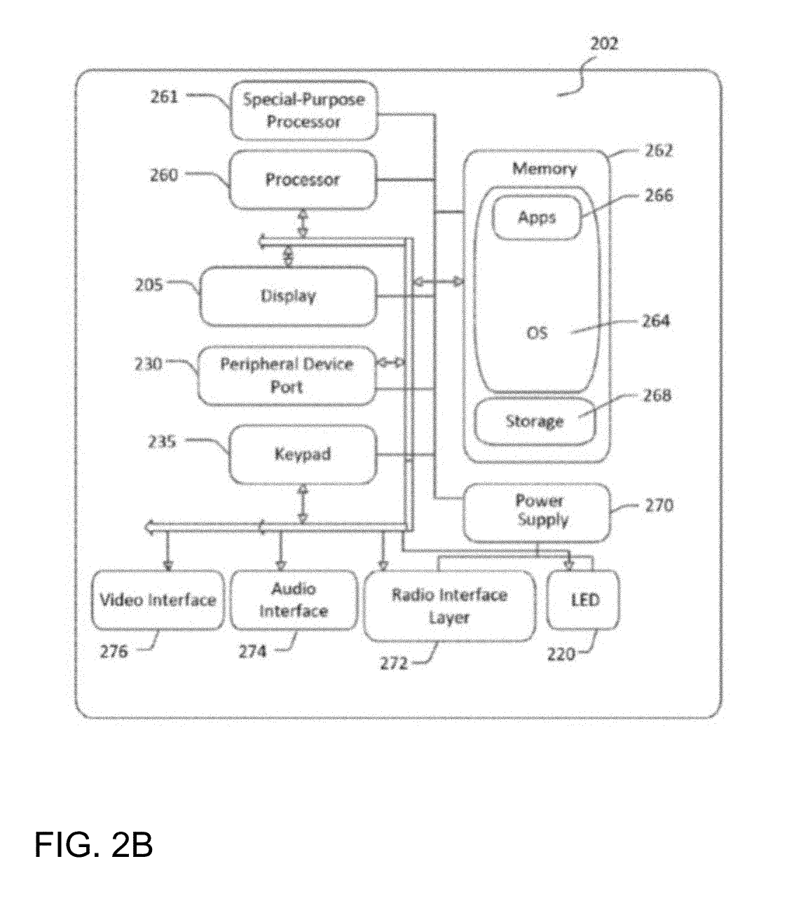

FIG. 3 illustrates further aspects of an exemplary embodiment of a system for retrieving information. As shown, the system may include a mobile computing device 308 running client app 318, and may also include a server computing device 302 running server app 312. Information and data for use by client app 318 and/or server app 312 may be stored in a tangible data storage device 316. Information stored in data store 316 may be accessed by server device 302 and by mobile 308. In embodiments, mobile 308 may access information stored in data store 316 directly via network 315, or indirectly by sending an appropriate message to server 302, which can then access the information identified in the message and send it to mobile 308. Mobile 308 can also access other resources via network 315, for example, one or more web servers. FIG. 3 illustrates web servers hosting first web site 324 having a first web address, second web site 326 having a second web address, and/or third web site 328 having a third web address.

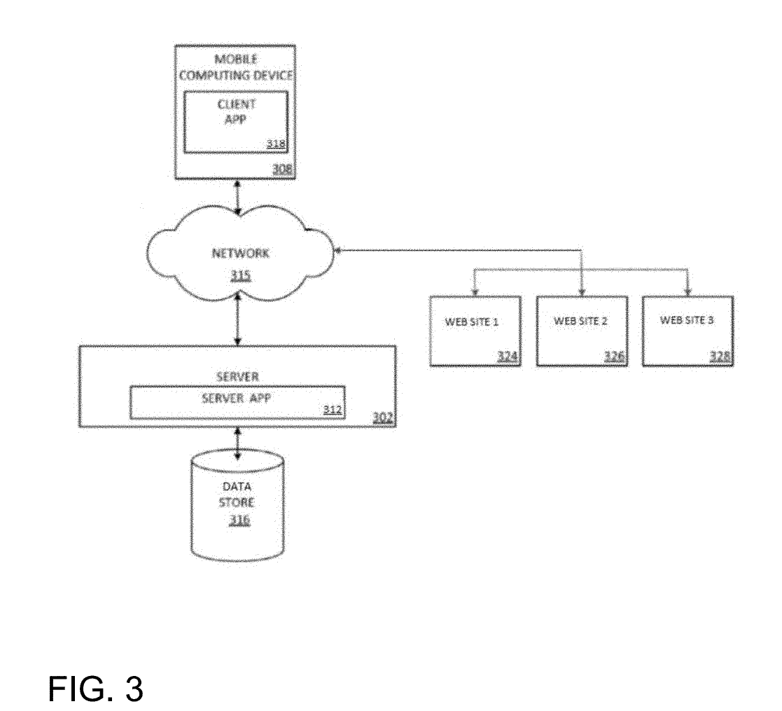

FIG. 4 is an exemplary “for sale” classified ad page 400, in which most of the ads are conventional ads providing a brief description of the item for sale, an offer price, and a contact phone number and location. To obtain more information, a prospective buyer has no choice but to call the contact phone number and begin asking questions. It should be appreciated that other types of ads may provide other or additional information, but in general the information immediately and conveniently available to the reader is limited by the text and images contained in the ad.

However, four ads, 410, 420, 430, and 440 are shown in FIG. 4 that accord with aspects of the present disclosure. Each of these ads contains a text string comprising an opening tag (#CMore), a closing tag (##), and intermediate alphanumeric characters between the opening and closing tags. Alternatively or additionally, in embodiments the intermediate characters may include other symbols as well. The intermediate characters can be used as a “key” to identify specific information to be retrieved, for example, in accordance with the operation of the system illustrated in FIG. 3 and corresponding disclosure.

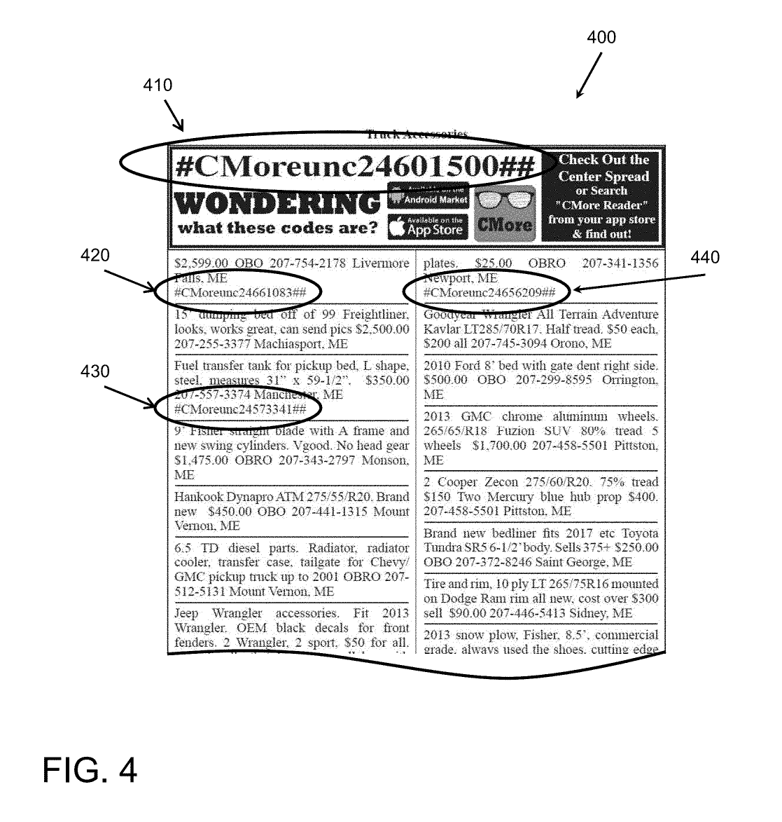

FIG. 5 illustrates an exemplary embodiment of information stored in data store 316. In this embodiment, a table is shown comprising a plurality of records, each record comprising a plurality of fields. One of the fields has column header “key”, and is used in the illustrated embodiment in conjunction with the intermediate characters between the opening and closing tags shown in the ads circled in FIG. 3. Another field is labeled “redirect”, and contains the address of a web site that has content relevant to the corresponding ad in FIG. 3. In an embodiment, instead of or in addition to a redirect web site address, other relevant information may be similarly retrieved, for example from one or more other or additional fields in the record identified by the key field.

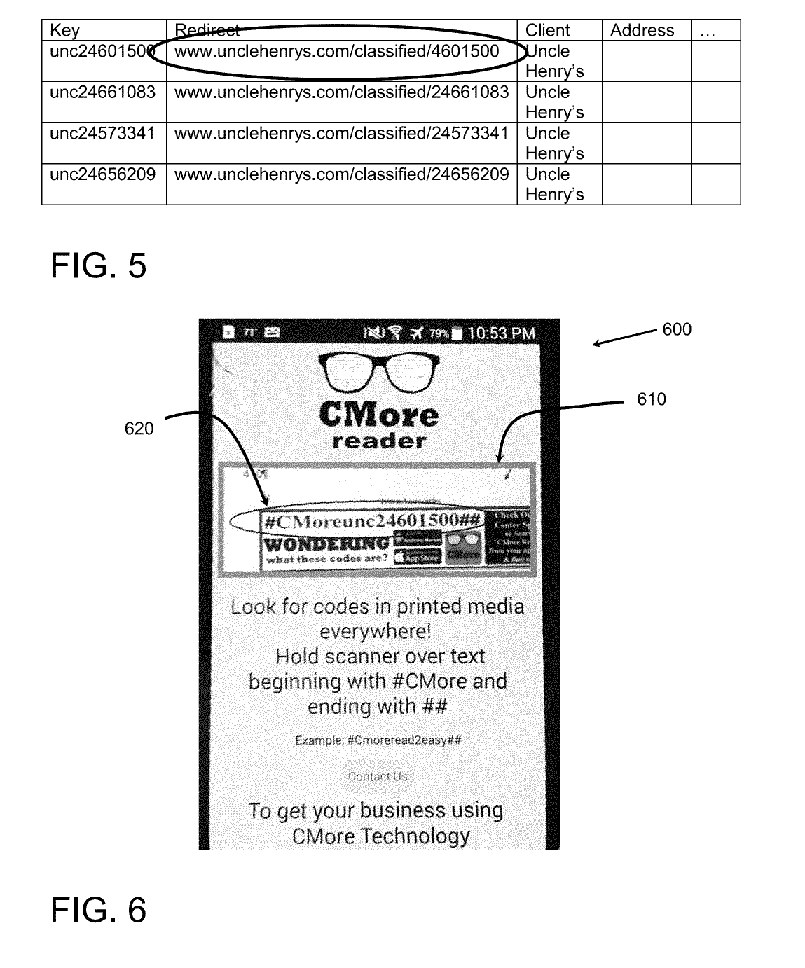

FIG. 6 illustrates an embodiment of a user interface 600 of an app that was downloaded by a smart phone from an app store. The app is running on the smart phone, such as the mobile 200 illustrated in FIGS. 2A and 2B. When the camera is activated by the app, an image of at least part of the camera's field of view is displayed in window 610 of user interface 600. The image may be refreshed periodically at a predetermined rate, for example, every second, or every 10^{th} or 100^{th} of a second. As illustrated in FIG. 6, the camera on the smart phone may be pointed by a user at the printed ad shown in FIG. 4., and the user may center in window 610 an image of the ad captured by the camera. The app performs OCR on the text in the image, analyzes the text, and recognizes a pattern of characters, such as characters 620 highlighted in FIG. 6 with an oval. The recognized pattern of text comprises a predetermined opening tag (here, #CMore, although other opening tags could be used) followed by a predetermined closing tag (here, ##, although other closing tags could be used), and comprising intermediate characters between them (here, unc24601500, although other characters could be used).

In the embodiment illustrated in FIG. 6, the intermediate characters are used by the app to obtain additional information about the subject of the ad. Responsive to recognizing the pattern of characters, the app obtains a web address corresponding to the intermediate characters (as will be described); it launches or gains control of a web browser application on the smart phone 200/mobile 308; and it directs the browser to view the web address obtained. In the figures, the intermediate characters between the opening and closing tags are “unc24601500”, defining a key for retrieving additional information. The key is used to access the database of FIG. 5. The database may be accessed directly by mobile 200 via network 315, and the key may be used to obtain a redirect web address. Additionally or alternatively, the key may also be used to retrieve other information stored in other fields of the same record, or elsewhere in a location indicated by an identifier based on the key. Additionally or alternatively, the further information may be obtained indirectly by the mobile 308 sending a message via network 315 to server 302, or more particularly by client app 318 sending a message to server app 312. The server may then retrieve the redirect web address and/or other information corresponding to the key, and send it to the mobile 308. The mobile 308 may receive the information and display it. Or, if a redirect web address is received, the mobile may launch or gain control of a web browser app running on the mobile, and direct the browser to the received web address. In embodiments, the client app 318 may additionally or alternatively initiate one or more other actions corresponding to the recognized key.

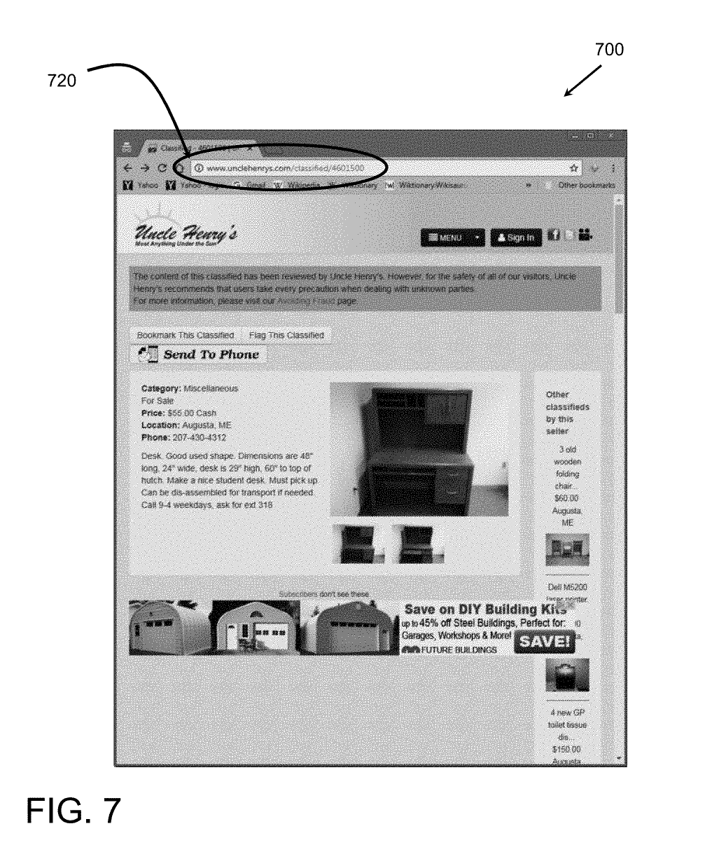

A screen capture 700 of an exemplary landing page of a web site at the web address obtained is shown in FIG. 7. As can be seen from FIGS. 4, 5, and 6, the circled portion of ad 410 comprises opening tag “#CMore”, closing tag “##”, and intermediate character string “24601500”. The intermediate character string is a key that identifies the first data record in the table of FIG. 5 to identify a corresponding “redirect” web address. Directing a web browser to that web address, 720, returns the web page shown in FIG. 7.

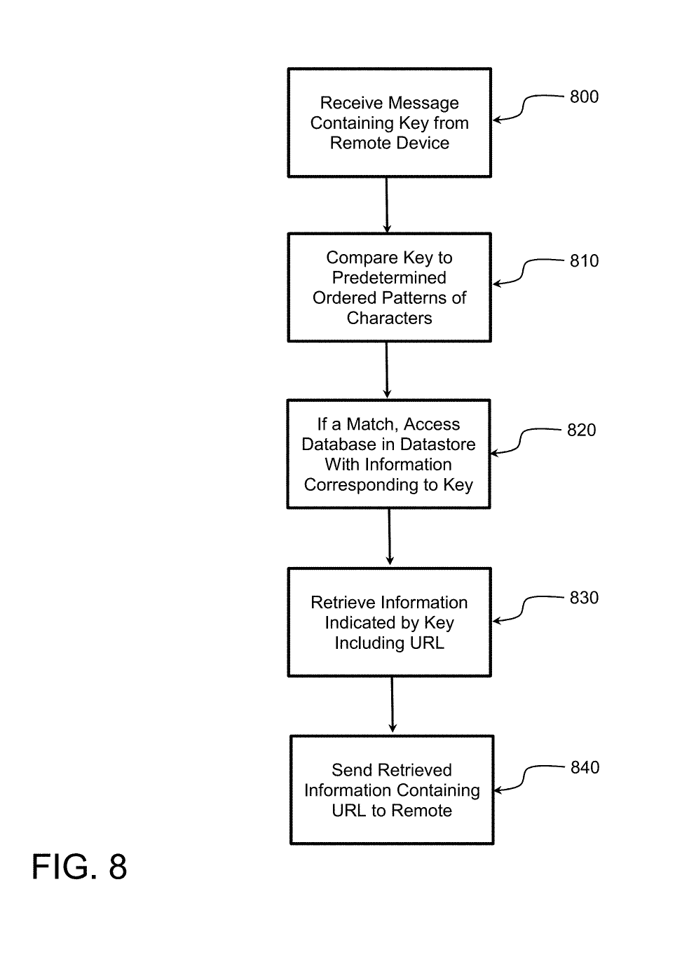

FIG. 8 is a flow chart of an exemplary method carried out by a server on a network, such as server 302. The method begins when a message containing a key is received from a remote device, 800. The server compares the received key to a plurality of stored keys, each of which comprises a predetermined ordered pattern of characters, 810. If a match is found, a database stored in a data store is accessed, and the information corresponding to the matched key is located, 820. The information indicated by the matched key is retrieved, 830. The server then sends the retrieved information to the remote device that sent the key, 840. In an embodiment, the information retrieved and sent includes a uniform resource locator (URL).

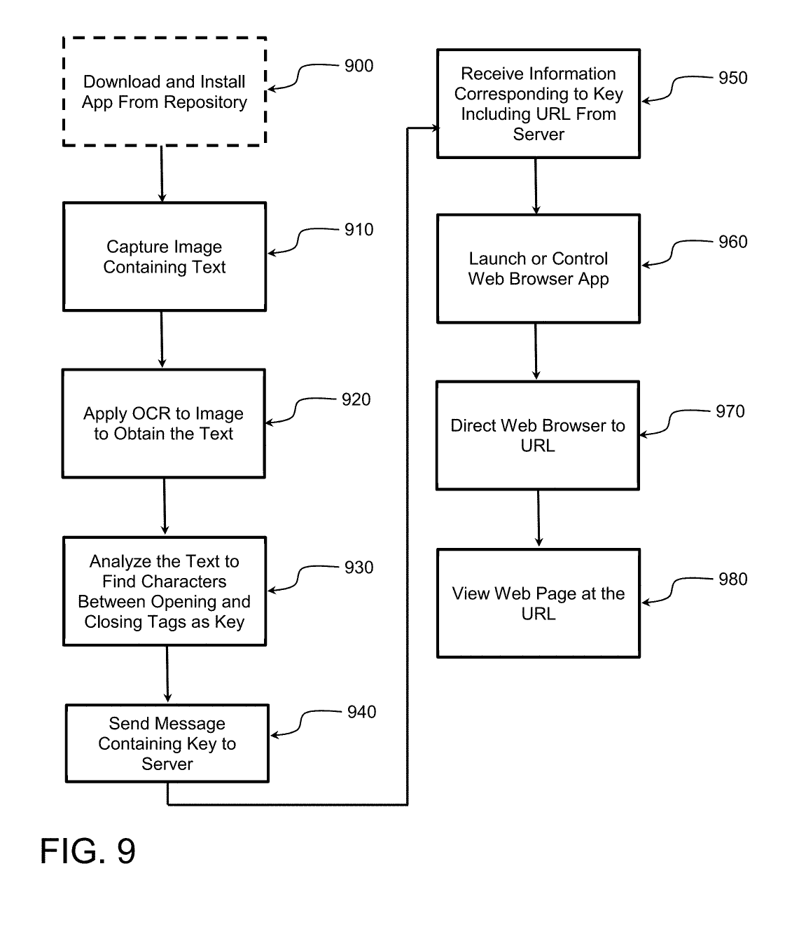

FIG. 9 is a flow chart of an exemplary method carried out by a mobile communication device, such as mobile device 308. The method begins when a mobile device of a user captures an image containing text, 910. In an embodiment, the mobile device has a camera, and the image is captured as the user points the camera at printed material such as an advertisement that contains text. In an embodiment, the user launches an app downloaded and installed from an app repository such as an app store, 900. The app controls the camera to capture the image containing text. In particular, the user points the camera toward text that the user recognizes conforms to a predetermined pattern comprising an opening tag and a closing tag with intermediate characters between them, and the image captured by the camera includes the tags and intermediate characters. Optical character recognition (OCR) is applied to the captured image to obtain the text, 920. The text is analyzed to find a pattern including characters between opening and closing tags, 930. The found pattern comprises a key, which is sent in a message to a server on a network to which the mobile device is operatively coupled, 940.

Thereafter, the mobile device receives information from the server corresponding to the key, 950. In an embodiment, the information includes an URL, and the app on the mobile device launches or gains control of a web browser, 960, and directs the web browser to a web address in the URL, 970. A web page at that web address can then be viewed by the user, 980.

In an exemplary operation, camera 230 of smart phone 200, such as that illustrated in FIGS. 2A and 2B, can be used to obtain an image of text in a print ad or the like. In the illustrated embodiment, the intermediate symbols are alphanumeric characters associated with information stored in a tangible storage device, although other types of symbols, corresponding to similar or dissimilar types of associations, may be used. For example, the intermediate symbols may correspond to an action or process to be initiated, instead of corresponding to information to be retrieved.

Any convenient method of data storage and retrieval known in the art may be used to obtain stored information corresponding to a key equal to or based on the intermediate symbols. For example, a data table or other database may be stored containing a plurality of records, each identified by a unique key. This data may be downloaded from a server on a network, stored in a storage device of the mobile 200, and synchronized according to a set schedule or frequency, for example. If so, the mobile 200 may obtain the information corresponding to the key from its own storage. Or, the data may reside only in a data store 316 on the network. If so, the mobile 200 must obtain the corresponding information from data store 316, either directly or via a server on a network. Each data record of the database or table may contain at least two fields—a key field that identifies the record, and another field containing information being retrieved, such as a redirection web address.

Exemplary embodiments have been described above with reference to figures showing, for example, block diagrams and/or operational illustrations of exemplary methods, systems, and computer program products according to aspects of the disclosure. Unless otherwise specified, elements of the systems and devices described may be arranged differently than shown; and functions, acts, and steps described may occur out of the order shown or described. For example, two blocks shown in succession may in fact be executed substantially concurrently or the blocks may be executed in the reverse order, depending upon the functionality involved.

Although the invention has been described and illustrated in exemplary forms with a certain degree of particularity, the descriptions and illustrations have been made by way of example only. Unless explicitly stated otherwise, numerous changes in the details of construction, and combination and arrangement of parts and steps, may be made without deviating from the scope of the invention. Accordingly, such changes are understood to be inherent in the disclosure. The invention is not limited except by the appended claims and the elements explicitly recited therein. The scope of the claims should be construed as broadly as the prior art will permit. All elements of all of the claims may be combined with each other in any possible combination, even if the combinations have not been expressly claimed.

What is claimed is:

1. A server operatively coupled to a network, the server comprising at least one processing unit operatively coupled to at least one memory, the memory storing computer executable instructions that, when executed by the at least one processing unit, cause the server to perform a method, the method comprising:
receiving a message sent via the network by a remote device, wherein the remote device sent the message responsive to recognizing a predetermined text pattern containing an initial portion as an opening tag and a final portion as a closing tag, wherein the opening tag and the closing tag enclose between them at least one recognized intermediate symbol associated with information stored in a tangible storage device accessible to the server;
retrieving the information from the storage device; and
sending the retrieved information via the network to the remote device.

2. The server of claim 1, wherein the retrieved information is retrieved from a location in a database stored on the storage device, wherein the location corresponds to, in combination, at least one of the opening tag, the at least one intermediate symbol, and the closing tag, as a key.

3. The server of claim 2, wherein the key is compared to a plurality of predetermined ordered patterns of symbols to determine whether the key matches one of the predetermined patterns of symbols; and
in the case there is a match, retrieving from the database the information corresponding to the matched key, wherein the information includes a uniform resource locator (URL) usable by a browser application on the remote device.

4. The server of claim 3, wherein the retrieved information is sent to the remote device.

5. The server of claim 4, wherein the URL comprises a web address in hypertext transfer protocol (HTTP) format usable by a browser application on the remote device.

6. A method for use by a server operatively coupled to a network, comprising:
receiving a message sent via the network by a remote device, wherein the remote device sent the message responsive to recognizing a predetermined text pattern containing an initial portion as an opening tag and a final portion as a closing tag, wherein the opening tag and the closing tag enclose between them at least one recognized intermediate symbol associated with information stored in a tangible storage device accessible to the server;
retrieving the information from the storage device; and
sending the retrieved information via the network to the remote device.

7. The method of claim 6, further comprising retrieving information from a location in a database stored on the storage device, wherein the location corresponds to, in combination, at least one of the opening tag, the at least one intermediate symbol, and the closing tag, as a key.

8. The method of claim 7, further comprising before the retrieving, comparing the key to a plurality of predetermined ordered patterns of symbols to determine whether the key matches one of the predetermined patterns of symbols; and
in the case there is a match, retrieving from the database the information corresponding to the matched key, wherein the information includes a uniform resource locator (URL) usable by a browser application on the remote device.

9. The method of claim 8, further comprising sending the retrieved information to the remote device.

10. The method of claim 9, wherein the URL comprises a web address in hypertext transfer protocol (HTTP) format usable by a browser application on the remote device.

11. A mobile communication device (mobile) operatively coupled to a network, the mobile comprising at least one processing unit operatively coupled to at least one memory, the memory storing computer executable instructions that, when executed by the mobile's at least one processing unit, cause the mobile to perform a method, the method comprising:
capturing an image and analyzing the image, and
responsive to the analysis, sending a message to the server via the network.

12. The mobile of claim 11, wherein the computer executable instructions were downloaded and installed onto the mobile as an app.

13. The mobile of claim 11, wherein the analysis includes optical character recognition (OCR) of an image containing text.

14. The mobile of claim 13, wherein the analysis includes recognizing in the OCR'd text a predetermined text pattern containing an initial portion as an opening tag and a final portion as a closing tag, wherein the opening tag and the closing tag enclose between them at least one recognized intermediate symbol; and
wherein a combination of at least one of the opening tag, the intermediate symbol(s), and the closing tag form a key that corresponds to information stored in a tangible storage device accessible to a server operatively coupled to the mobile.

15. The mobile of claim 14, wherein the mobile sends a message to the server responsive to recognizing the predetermined text pattern, wherein the message comprises the key.

16. The mobile of claim 15, wherein the mobile, after sending the message to the server, receives from the server a message containing the information corresponding to the key.

17. The mobile of claim 16, wherein the received message comprises a uniform resource locator (URL) usable by a browser application running on the mobile.

18. The mobile of claim 17, wherein the URL comprises a web address in hypertext transfer protocol (HTTP) format.

19. The mobile of claim 18, wherein the browser application is directed to the web address.

20. The mobile of claim 19, wherein the image containing text is part of a print advertisement, and a web page at the web address provides information pertaining to a subject of the advertisement.
